(19) United States
(12) Patent Application Publication
(10) Pub. No.: US 2009/0150345 A1
(43) Pub. Date: Jun. 11, 2009

(54) Web Domain Data Replication System

(75) Inventor: Andrew S. Van Luchene, Santa Fe, NM (US)

Correspondence Address: GONZALES PATENT SERVICES, 4605 CONGRESS AVE. NW, ALBUQUERQUE, NM, 87114, US

(73) Assignee: LEVIATHAN ENTERTAINMENT, Santa Fe, NM (US)

(21) Appl. No.: 11/951,851

(22) Filed: Dec. 6, 2007

(51) Int. Cl. G06F 17/30

(52) U.S. Cl. 707/3; 707/E17.108

(57) ABSTRACT

A system and method of increasing the visibility of a website by automatically generating one or more additional linked webpages relating to the website. Information used in the webpages may be gathered from the original website or the websites of one or more third party website. Such a system may increase the ranking of a website in the results of one or more search engines.

### BACKGROUND

Online searches driven by Web-based search engines have proven to be one of the most prevalent uses of computer networks such as the Internet. Computer users can employ a variety of search tools to search for information as well as goods and services. The search tools return listings of content providers that have information related to the user's search. Once users have identified the content of interest, they can frequently click on a listing to connect to a content provider's website for related information or to view a particular product or service.

Content providers generally seek to increase the traffic to their websites. However, search engines frequently return pages of results making it easy for any one content provider to be overlooked. It would therefore be advantageous for a content provider to have improved methods and apparatus that would cause their listing to appear as early as possible in the search results.

### BRIEF DESCRIPTION OF THE DRAWINGS

FIG. 1 is a block diagram depicting a network according to an embodiment of the present disclosure.

FIG. 2 is a block diagram depicting a system 100 according to one embodiment of the present invention.

FIG. 3 illustrates a method of adding data to a sub-page according to an embodiment of the present invention.

FIG. 4 illustrates a method of linking web-pages according to an embodiment of the present invention.

FIG. 5 illustrates a method of generating sub-webpages based on an embodiment of the present invention.

### DETAILED DESCRIPTION

Web search tools or search engines seek to classify or categorize websites and web pages that are accessible via the internet. Such classification may be based on understanding each site's purpose, description, content, usefulness and popularity. Search engines attempt to provide end users with information or results based, at least in part, upon an end user's search string or other end user provided search criteria.

Many methods are employed by search engines to determine the placement of listings in search results. Some search engines rank listings based on payments received by advertisers. Others look at meta tags, information placed in the HTML header of a Web page, or other displays of keywords. One common technique of ranking results includes variations based upon a method that determines the popularity or usefulness of a master domain or other web page based upon the number and type of interconnections to the domain or web page. Interconnections may be, for example, hyperlinks made to or from such master domain or other web pages, references to websites in master domain or other web pages, review of such master domain or other web pages, or any other type of link or reference to such master domain or other web pages. It is therefore in the interest of master domain or other web page owners to improve the interconnections related to their website and thereby increase the placement of their listing in various search engines.

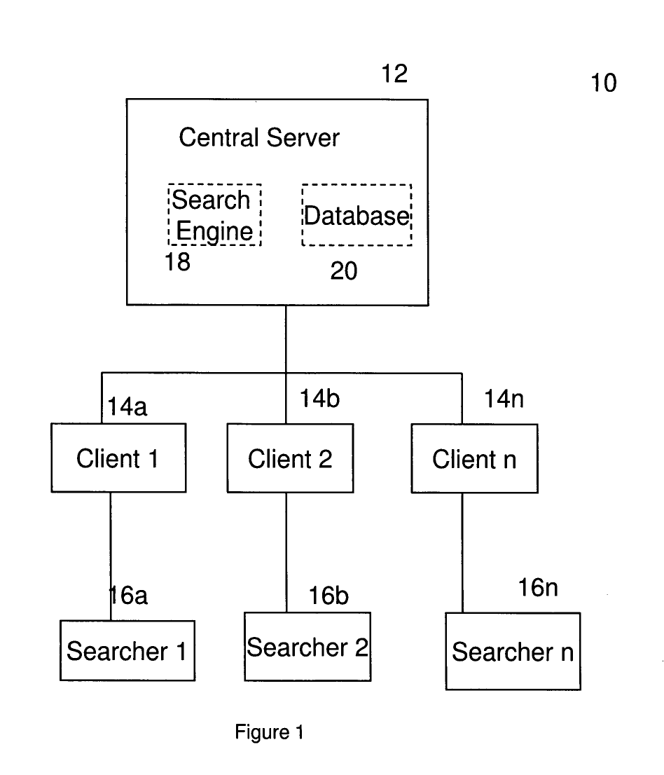

The herein described aspects and drawings illustrate components contained within, or connected with other components that permit improved listing status in search engines, resulting in a greater web presence. It is to be understood that such depicted designs are merely exemplary and that many other designs may be implemented to achieve the same functionality. Any arrangement of components to achieve the same functionality is effectively associated such that the desired functionality is achieved. FIG. 1 provides an exemplary network which may be used to support a virtual environment.

Turning now to FIG. 1, a system 10 suitable for use according to one embodiment of the present disclosure is depicted. As shown, the system includes a central server 12 which is in electronic communication with one or more client computing devices 14. Each client computing device 14 allows one or more users 16 to access central server 12. System 10 is configured such that a search engine can receive a search request from a user, retrieve search results from one or more databases, and provide the search results to the user. Numerous configurations for the locations of the search engine and databases are possible. According to the depicted embodiment, a search engine 18 and one or more databases 20 are hosted by central server 12. However, it will be readily understood that search engine 18 may, for example, be located on one or more client computing devices 14, on another server in electronic communication with central server 12, or elsewhere, so long as search engine 18 is in electronic communication with and accessible by the client computing device. Moreover, it will be further understood that databases 20 may be located, collectively, or individually, in numerous locations in the system, including without limitation, on central server 12, on a different server, on a client computer device, etc. Moreover, it will be understood that search engine 18 may be capable of accessing a first database in a first location and a second database in a second location, etc. and assembling search results from multiple databases. Regardless of the location of the search engine and databases, the user will typically access the search engine through some type of user interface such as, for example, a web browser.

Central server 12 and client computing device 14 may be, for example, appropriately programmed general purpose or dedicated computers and computing devices. Accordingly, such devices will typically include a processor configured to receive and execute instructions from a computer program. Thus, it will be understood that the various processes and methods described herein may be implemented by an appropriately programmed general or purpose or dedicated computer or computing device.

For the purposes of the present disclosure, a “processor” means one or more microprocessors, central processing units (CPUs), computing devices, microcontrollers, digital signal processors, or like devices or any combination thereof. Typically a processor (e.g., one or more microprocessors, one or more microcontrollers, one or more digital signal processors) will receive instructions (e.g., from a memory or like device), and execute those instructions, thereby performing one or more processes defined by those instructions.

Thus a description of a process is likewise a description of an apparatus for performing the process. The apparatus can include, e.g., a processor and those input devices and output devices that are appropriate to perform the method.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

For the purposes of the present disclosure, the term “computer-readable medium” refers to any medium that participates in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, CD-RW, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) are well known and could be used to store and manipulate the data types described herein. Likewise, object methods or behaviors of a database can be used to implement various processes, such as the described herein. In addition, the databases may, in a known manner, be stored locally or remotely from any device(s) which access data in the database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Those having skill in the art will recognize that there is little distinction between hardware and software implementations. The use of hardware or software is generally a choice of convenience or design based on the relative importance of speed, accuracy, flexibility and predictability. There are therefore various vehicles by which processes and/or systems described herein can be effected (e.g., hardware, software, and/or firmware) and that the preferred vehicle will vary with the context in which the technologies are deployed.

With the exponential growth of information available on the Internet, consumers frequently use search engines to help them navigate and identify content of interest. Content providers such as advertisers and other web site owners in turn seek to increase the traffic of interested end users to their particular website. It is therefore in the interest of content providers to appear high on a list of search results where they are more likely to be selected by a consumer.

Information displayed in search engines is frequently obtained through the use of a spider or other web crawler. A spider is a program or automated script which systematically browses the internet. Web crawlers are frequently used to collect information about web page content, documents and hyperlinks discovered during this process, and return the information for inclusion in search engine databases. In general, web crawlers start with a list of uniform resource locators (URLs), the unique identifiers for a file that is accessible on the Internet, to visit. As the crawler visits these URLs, it identifies all the hyperlinks in the page and adds them to the list of URLs to visit. These added URLs are recursively visited according to a set of policies.

Search engines use a variety of algorithms to identify and rank listings based on information returned from spiders including information such as descriptions and keywords, link popularity, keywords in URLs and link text, themes, meta tags, and click popularity among others. One component of search engine algorithms is the number and importance of other sites linking to a particular page. It is therefore advantageous to content providers to increase the number of linkages to their page, thereby increasing the rank of their listing in search engines and increasing traffic to a particular website.

Various embodiments of the invention address this issue by providing a system and method of creating dynamic web pages that are fully operable, searchable and useable with links to master web pages or other pages whose promotion is desired. Such a replication system thereby increases the number of links to a web page thereby increasing the ranking of a particular website in search results. Web pages may be created by any of a myriad of ways. In some embodiments, web pages may be created by retrieving data from master domain pages or other websites including the websites of advertisers or content providers wishing to increase their rankings, third party websites, local vendor sites and national aggregators, or any other source of data regarding the content providers wishing to increase their presence. Data may be obtained by any means applicable. In some embodiments, data may be obtained by data scraping. In other embodiments, the system may access a group of digital files such as articles or images that have content that is relevant to the website being promoted. The data may be parsed into one or more categories based on the type or content of the data. From the data collected and the categories involved, dynamic web pages may be created that are fully operable, searchable and useable. In some embodiments, static web pages may be created. Pages may be created by any means applicable including by using genetic algorithms or any other learning of AI based application. In some embodiments, these created web pages may be independent. In other embodiments, the created web pages may be sub-pages of a master domain. The newly created web pages may link to each other and to one or more master domain pages creating a domain cluster. The system may create one or more domain clusters based upon information from any one or more of participating and non-participating local vendor sites, national aggregator sites and store or otherwise make them available to the system and linked to each other. In some embodiments, each domain cluster may be assigned the same or different IP address or reside on the same or different servers. In exemplary embodiments, the newly created web pages are referred to as sub-pages or sub-webpages, however these sub-pages or sub-webpages may be independent, i.e. a master domain page or have unique IP addresses or may actually be sub-pages of a master domain page.

Every time, or at various intervals, any data or subset of the data is modified, the content of the web pages, including the sub-pages or domain clusters may also be refreshed or modified and saved in a format that can be found, examined or otherwise searched by one or more search engine spiders or web crawlers. Such web pages could be used to modify search engine results for any type of website, business entity, organization, network or association of web pages.

For example, content providers may hire a replication system to increase their web presence. The replication system may have a series of templates of web pages that will be created, or may create custom templates for each client. The style of the templates may vary depending on the type or client, the type of search engines on which the client wishes to improve their ranking, the content of the web page to be created, or any other applicable criteria. In some embodiments, existing templates may be modified to reflect changes in web crawlers or search engine programs. Once a template is selected, it may be associated with one or more of the client's master domains or may be used to create a master domain. In some embodiments, each master domain may be associated with a different template. In other embodiments, each master domain of a particular client may have the same template or any combination thereof. In some embodiments, there may be multiple templates associated with any one master domain. The replication system may create a replication cluster—i.e. two or more sub-domain names for replicated web pages. Such sub-domain names may be created by any means applicable. In some embodiments, sub-domain names are created by parsing content into sub-modules or other subsets of the total data. For example, sub-domain names may be date, location, amenity, product, size, color, price, or otherwise specific for some category of information. In other embodiments, the replication system may create independent web pages that are not sub-domain names. Data may be collected in relation to the sub-domain name from a variety of sources including the client as well as third party sources. In some embodiments, a master domain may be a promotional website and may include information from a variety of data providers. A specific web page based on the sub-domain name may then be created using the chosen template. Each sub-domain page or other created web page may be linked to each other, the master domain, as well as related third party websites. In some embodiments, when the data on which the content is based changes, each page may be updated automatically. Organic placement of the sub-domain name or the master domain name may be periodically tested and relative movement in a search engine listing may be tracked. In some embodiments, the success of particular sub-domain names may be measured and optimal sub-domain names may be determined and used for the creation of additional sub-domain pages.

For example, a system retrieves room availability from 60 hotel properties located in the Santa Fe area for the next 365 days. Such data may be gathered directly from the hotels' inventory or reservations system or third parties such as a consolidator. The properties may be arranged in one or more categories such as all lodging, location, date, amenities, price, hotels close to the plaza, resorts, retreats, Inns, Motels, star ratings, price groupings, etc. Such groups may have some amount of overlap or may be exclusive. For example, a hotel may belong to groups such as “all lodging,” “motels and Inns close to the Plaza,” “properties with pools,” “two-star properties,” “properties with room service,” “properties with banquet facilities,” or any other subcategory. The system may be linked to several relevant master domain or other relevant web pages such as santafetrips.com, santafean.com, and visitsantafe.com. A static or dynamic web page may be automatically generated by the system and given a unique title. In some embodiments, independent web pages may be created with this information.

The system generates names for sub-pages or other web pages that are most likely to be read and rated favorably by search engine spiders. In some embodiments, the system may test names for web pages for each domain cluster and measure which names yield the best organic placement, i.e. non-paid rank or position within search engine results, for the master domain or other site being promoted. In one embodiment, the system can modify the sub-domain names to optimize the search engine placement for the web page associated with the sub-domain and the master domain name linked to a particular group of sub-domain names.

In another embodiment, the system may submit search engine queries to one or more search engines and gather and analyze the resulting data set. By analyzing and comparing such results, with the underlying generated sub-pages, the system can measure its efficacy. By reviewing results data, the system may periodically test various competing sub-page creation and linking methods to determine which method of creation currently provides the best possible results. This allows the system to remain responsive to changes to algorithms used by search engines. When a given method proves to be more effective than another during a given timeframe, the system may tend to create more sub or other pages and linkages using the more effective methods. If it is determined that a method is losing its effectiveness, the system can select from among one or more other methods to generate sub or other web pages that provide better search outcomes. In some embodiments, comparisons of search data may be used to identify possible competitive websites. Such information may be provided to members using the replicating system.

For example, the system may generate a unique, linked page for each day, each week, each category, discount types, restrictions, physical location, proximity to other locations or attractions, room type, pricing, star level, availability, any other desired criteria or any combination thereof. Generally, the more pages that can be generated that contain links and interconnections to the other relevant or participating owner's pages or the generated pages, the more likely the desired results will be achieved. Therefore, the system attempts to create the maximum number of combinations and permutations for which there is sufficient information and to create the desired links and associations among the generated pages and those that served as the basis for generating such additional pages. These pages may be independent domains, or may be sub-pages to a master domain page. The unique web pages are also loaded with searchable content about Santa Fe “meta tags” and linked to each other and other domain sub and master pages (for example santafean.com/january1-2007/hotelsclosetotheplaza has a link to santafetrips.com/january1-2007/hotelsclosetotheplaza and vice versa).

For example, a regional promotional site may create a master domain such as traveltocityx.com. The promotional site may wish to increase its presence on the web and therefore may hire or otherwise retain the services of a replication search system. The promotional site may include information about events, lodging, restaurants, galleries, points of interest, performing arts, shopping, or any other type of activity in a particular area. The promotional site may select one or more templates to be used for the creation of sub-pages. The system may create sub-domain names based on the types of lodging, the types of restaurants, the types of events, types of galleries, shopping, locations of the lodging, events and restaurants, the dates of availability of the lodging, events and restaurants. For example, if the exemplary master domain is traveltocityx.com, exemplary sub-domain names may include: traveltocityx.com/january1-2007/hotelsclosetotheplaza; traveltocityx.com/january1-2007/four star hotels; traveltocityx.com/january1-2007/hotels with restaurants; traveltocityx.com/january1-2007/events; traveltocityx.com/january1-2007/theater listings; traveltocityx.com/January1-2007/regionalcuisine; santafean.com/January1-2007/familyfriendly restaurants; traveltocityx.com/january2-2007/hotelsclosetotheplaza; traveltocityx.com/january2-2007/four star hotels; traveltocityx.com/january2-2007/hotels with restaurants; traveltocityx.com/january2-2007/events; traveltocityx.com/january 2-2007/theater listings; traveltocityx.com/January 2-2007/regionalcuisine; traveltocityx.com/January2-2007/familyfriendlyrestaurants; traveltocityx.com/restaurants; traveltocityx.com/lodging; traveltocityx.com/events; traveltocityx.com/restaurants/close to the plaza; or any other combination or sub-combination of sub-domain names relating to the type of information generally available on the santafean.com website. The sub-domain names may be tested for placement in search engines to determine the most effective sub-domain names. The content of the sub-domain names may be acquired from santafean.com, websites owned by the entities being promoted such as a restaurant website, hotel website, gallery website; theater website; national aggregators or consolidators or event website or other third parties. Sub-domain pages are then populated with the information gathered. In the event that the information changes, changes may be made automatically to one or more relevant sub-domain pages. Each page may then be linked to each other. For example, each sub-domain page may be linked to the master domain page traveltocityx.com. A lodging page may include links to nearby restaurants or events. A shopping page may include links to nearby lodging or any other combination. Each unique page may provide relevant searchable content as well as reservation services and trip planning services.

Some search engines use usage data to affect, in whole or in part, the outcome or search results. In some embodiments, the system may provide a means for clicking through, or otherwise selecting a web page or links on a web page and thereby artificially increasing the traffic to particular web pages. Such a program may use some or all of the following steps:
a. Conduct a specified search query on a periodic basis in a search engine
b. Click on a specified/approved listed website in the search results
c. Retrieve a website index
d. generate a set of links from the table of contents (links to websites on the pages in the index)
e. Click through links
f. Store clicked links as “spider generated” (so that they are not billed for)

In another embodiment, the system can track the length of time between search spider crawls and alter the way it indexes the domain sub pages to generate the optimal crawl time between pages. If there are multiple domain clusters, the system can test different page indexing and content strategies, find optimal strategies, and cross pollinate strategies with other domain clusters. A genetic algorithm can be used to manage the index testing and restructuring to optimize the indexing of subpages of one or more web clusters over time. Such a program may use some or all of the following steps:
a. Retrieve search spider crawl data from a website
b. Alter website index based on crawl frequency
c. Store altered web index

In some embodiments, the providers of the replication system may choose to charge fees for such services. Service fess may be static, for example a monthly fee or other subscription price, or dynamic, e.g., based upon any applicable means, including, but not limited to, the number of sub-pages generated (whether independent or subservient), the frequency of updates, relative or overall success or ability of the replication system to favorably affect search results outcome, the number of transactions, the number of selections of a particular website, the traffic of a particular website, changes in traffic of a particular website, increases in traffic to a particular website, changes in the number of transactions, the total number of web pages generated or maintained, payment history, account type, any other method of billing or any combination thereof. In some embodiments, the ranking of web pages in a search result or the number of web pages and links created by the replication system may be determined by the fees paid. For example, entities can pay premium fees to have more pages generated than a competing entity. In other embodiments, the number of pages and links or the placement of websites with a ranking may be rotated.

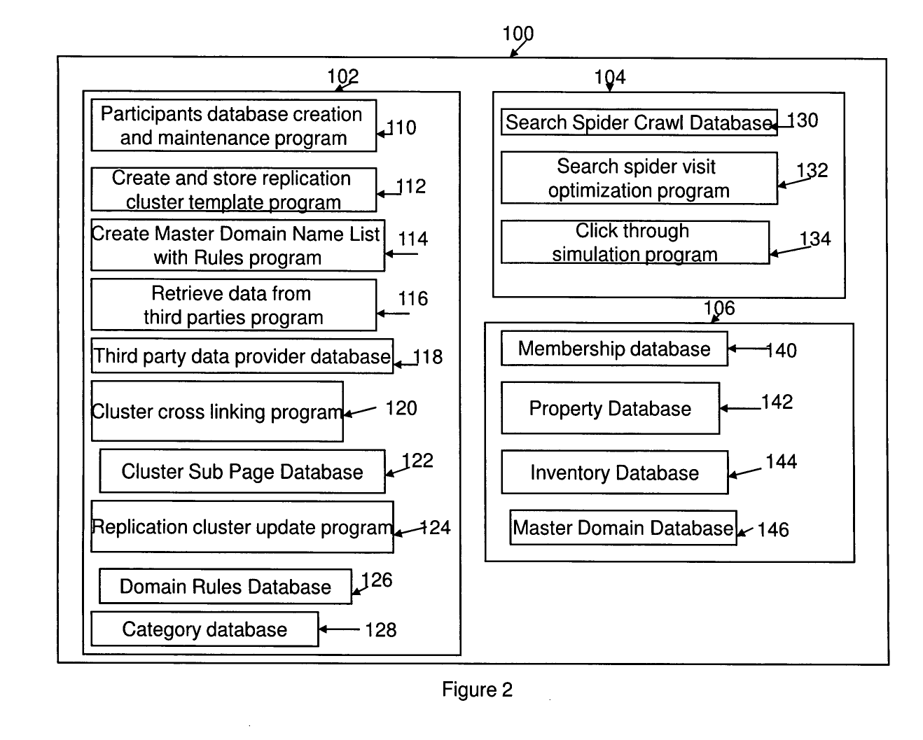

An exemplary system 100 configured to provide a replication system for lodging websites as described above is shown in FIG. 2. As shown, system 100 may include a replication server 102, a results optimization server 104 and a membership server 106 or any other combination of servers, programs and databases. In some embodiments, the various programs and databases described below may be located on one or more servers.

Replication server 102 may include a variety of programs and databases including, but not limited to, participants database creation and maintenance program 110, create and store replication cluster template program 112, create master domain name list with rules program 114, retrieve data from third parties program 116, third party data provider database 118, cluster cross linking program 120, cluster sub page database 122, replication cluster update program 124, domain rules database 126, and category database 128.

Results optimization server 104 may include a variety of programs and databases including, but not limited to, search spider crawl database 130, search spider visit optimization program 132, click through simulation program 134, or any other programs or databases useful in determining the placement of search results or optimizing that placement.

Membership server 106 may include a variety of programs and databases including, but not limited to, membership database 140, property database 142, inventory database 144, and master domain database 146.

Third party data provider database 118 may include information on property reservation engines and third party reservation engines and may include information such as Third Party ID, Third party type, third party billing information, and third party XML feed, or any other information related to identifying information or websites related to a particular third party.

Cluster sub page database 122 may include information such as domain name ID, subdomain name ID, and sub domain page template, or any other information related to a cluster of subpages.

Domain rules database 126 may include information regarding which properties are relevant to which categories of data such as the domain ID and the rules involved in placing properties or other inventory in particular categories.

Category database 128 may include information regarding the classification of particular types of content such as inventory. For example, the category database may include categories such as all lodging, hotels close to the plaza, hotels with a pool, hotels in Santa Fe or any other relevant category. The database may include the category ID, category name, category rules and a category descriptor as well as any additional information or programs useful in identifying and classifying the inventory and property of members of the replication system.

Search spider crawl database 130 may include information on spiders which have searched the web pages of members including the web pages created by the replication system. Such information may include, but is not limited to, the date, domain, number of pages crawled and the spider ID.

Membership database 140 may include information regarding participating entities and the websites they control. Such information may include, but is not limited to, the domain name to be improved, rules, billing information and billing criteria.

Property database 142 may include information on the property owned or controlled by the members and the webpages listing the properties including a property ID, property category, property domains and property subdomains.

Inventory database 144 may include information regarding the available inventory held by members including the property involved, the dates available, the type of inventory and prices.

In some embodiments, content providers who wish to use the replication system may apply for an account or membership with the replication system service provider. They may provide information such as the website(s) including master domains to be included in the replication program, the type of account they are interested in, the amount of replication in which they are interested, pricing, the level of web replication and frequency, the type of results they wish to achieve, information regarding the inventory or other property they are trying to promote as well as any other additional information relevant to their membership or account. Such information may be entered in one or more databases, for example in membership database 140. Information regarding the property and/or inventory they are trying to promote may be entered for example in property database 142 and/or inventory database 144. Information regarding the websites they wish to have included in the replication program may be stored, for example, in master domain database 146.

Clients may chose from one or more replication templates which may be used to create the replicated pages. In some embodiments, templates may be created for particular clients. In other embodiments, templates may have widgets or other programs embedded in them that are fully functional. For example, templates created for a particular date or hotel may be able to access other pages for other dates or accommodations. Templates may be unique to particular master domains or particular types of master domains, or a client may select one or more types of template depending on the type of sub-page to be created. The selection and application of a template may be made, for example using create and store replication cluster template program 112 which may use some or all of the following steps:

1. Receive a request to create a replication template.

2. Output template options.

3. Receive a template design based on template options.

4. Receive a master domain for the template design.

5. Store template design with master domain.

6. Update databases.

Once a template is selected, the replication system may generate replication clusters. Replication clusters are groups of two or more sub-domain names that are created by the replication system. Such sub-domain names that are created through any applicable means, for example, from or by parsing data relating to specific sub-modules or other categories or groupings. For example, such sub-domain names may be created by parsing the total inventory for 365 days into the inventory available each day such that sub-domains are some variation of the date of availability. The web pages may then be a subset of the total data, for instance the rooms available on Jan. 1, 2007 for a group of hotels that are located in Santa Fe, N. Mex. This data may be a sub set of all rooms available for a year for all or selected hotels listed in the Travelocity or one or more other travel site databases. A sub-module may include information based upon, provided by or derived from one or more websites. Data for use in the web pages may be acquired by any means feasible, for example through the use of data scraping routines which allow for the extraction of data from the display output of another program. Data scraping may be used to emulate an interaction with a web site including extracting information, filling out forms, navigating the site and dealing with the HTML received. Data may be obtained from the websites of clients, i.e. from the master domain pages or subpages or from third parties. In some embodiments, retrieve data from third parties program 116 may use some or all of the following steps:

1. Request data.

2. Receive data.

3. Sort data.

4. Update databases.

Once the data is obtained, a replication cluster may be generated using some or all of the following steps:

1. Retrieve data.

2. Parse data into appropriate sub-module.

3. Retrieve or generate a sub-domain name.

4. Create webpage from sub-module of date and sub-domain name.

5. Store webpage.

6. Update databases.

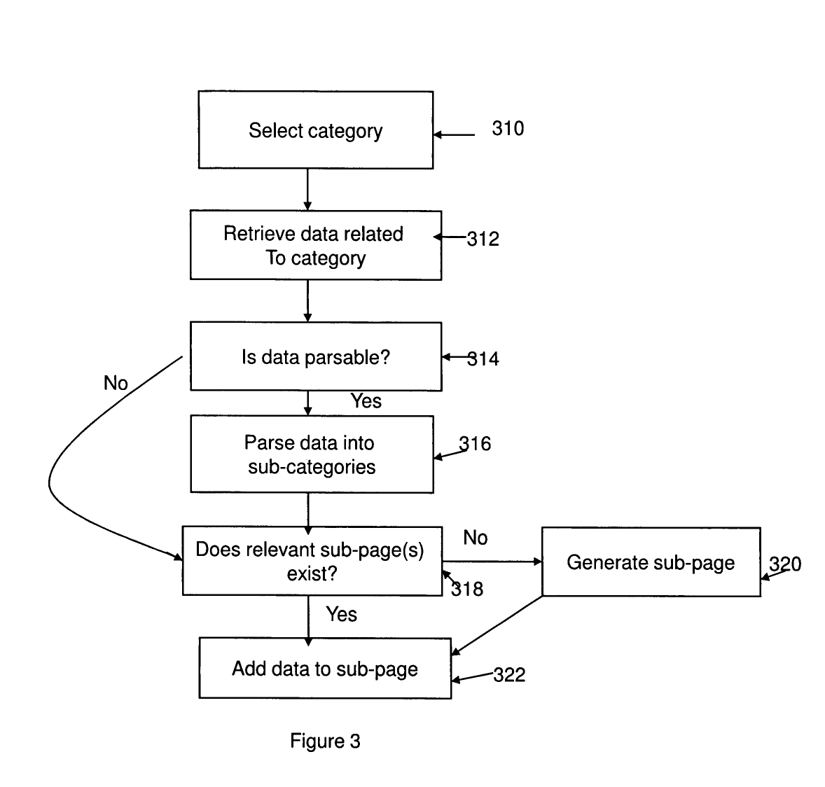

For example, some or all of the steps in FIG. 3 may be used in which data for a particular category is retrieved at 310. Categories may be any of a variety of partitions of data. For example, if the pages being updated relate to places to stay, categories may include all lodging, hotels, inns, resorts, retreats, spas, location, availability, pricing, amenities, any subset thereof, or any other applicable category. If the pages relate to restaurants, categories may include fine dining, Italian, French, Mexican, Tex-Mex, Japanese, Chinese, Greek, regional, family friendly, fast food, vegetarian, pizza, location, pricing, rating, availability, any subset thereof, or any other applicable category. If the pages relate to shopping, categories may include location, pricing, galleries, malls, chain stores, local stores, designers, outlets, clothing, housewares, children's, toys, sports equipment, outdoor gear, galleries, art, any subset thereof, or any other applicable category. If the pages relate to sites of interest, categories may include national parks, historic monuments, museums, locations, accessibility, state parks, recreational areas, any subset thereof or any applicable category. Similar pages may be created for entertainment venues, personal care, amenities, rentals, vacation properties, real estate, or any other type of product or service. Data related to a category is retrieved 312 and a determination is made 314 as to whether the data can be parsed into sub-categories. For example, the data retrieved may be for lodging in Santa Fe. The data may then be divided into types of lodging, availability, pricing, rating, or amenities, or any other sub category. If the data retrieved is not parsable, for example data was retrieved for a specific hotel on a specific date, a determination is made at 318 as to whether an appropriate sub-page for the data exists. If the appropriate sub-page exists, the data is added to the sub-page at 322. If the appropriate sub-page does not exist, the appropriate sub-page is generated at 320 and then the data is added at 322. If the data is parsable, it is parsed into the appropriate sub-categories at 316 and then a determination is made at 318 regarding the existence of the relevant sub-page as described above.

Some search engines alter the ranking of content depending on the number of linkages to and from a particular website as well as the popularity of the sites to which a web page is connected. In some embodiments, master domain pages and sub-pages may be cross-linked to each other to further increase the presence of the pages. Cross linking may also occur between sub-pages or between related sub-pages attached to different master domains. Such cross linkage may be accomplished using some or all of the following steps:

1. Retrieve sub-module web page.

2. Retrieve Master Domain.

3. Create hyperlink set for all sub-module web pages.

4. Attach hyperlink set to all sub-module web pages.

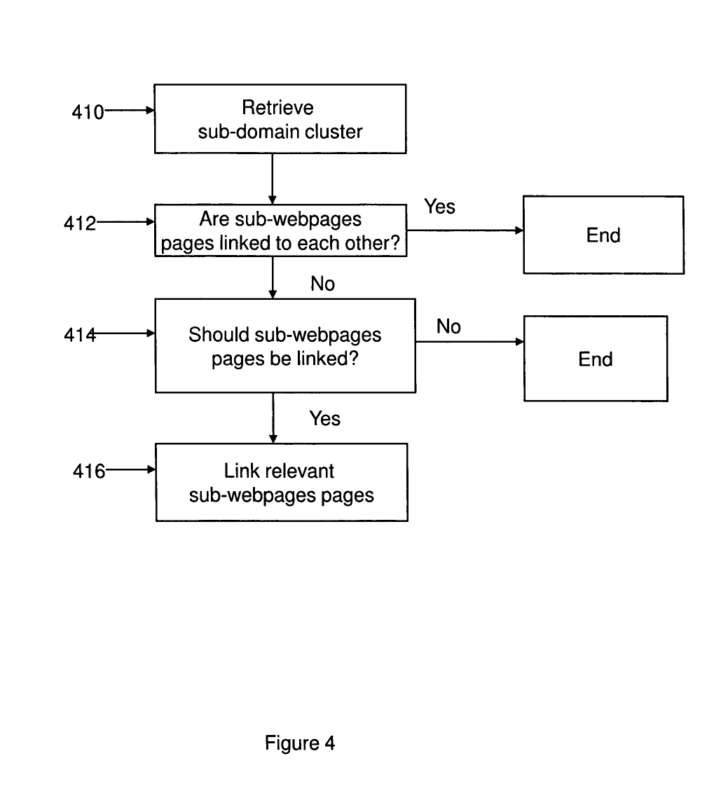

For example, some or all of the steps in FIG. 4 may be used in which a sub-domain cluster is retrieved 410. A determination is made 412 as to whether the web pages in the sub-domain cluster are linked to each other. If they are already linked, the program ends. If they are not linked, a determination is made 414 as to whether or not they should be linked. For example, some sub-categories of information do not necessarily need to be linked. If a category is for all lodging, the availability of different hotels does not necessarily need to be connected to each other, though it may be useful to connect pages dealing with the availability of a particular hotel. If the determination is made that they should not be linked, the program ends. If the determination is made that they should be linked, the necessary linkages may be made at 416.

In some embodiments, it may be useful to link pages to other related webpages or other master domains. For example, there may be more than one website related to tourism in Santa Fe. Web pages may additionally be linked to related webpages or other master domains using some or all of the following steps:
1. Retrieve replication clusters for all related Master Domains.
2. Retrieve hyperlink sets.
3, Attach hyperlink sets to all master domains and their replication clusters.
4. Update databases.

When new data is received, whether from data scrapes, third parties or clients, all of the sub-pages in a replication cluster may be updated, for example using replication cluster update program 124. An update may include a change of information on a particular web page or the addition or subtraction of additional sub-domain pages in a particular replication cluster. Such a program may use some or all of the following steps:
1. Receive data update.
2. Parse data into appropriate sub-modules.
3. Update existing replication clusters with updated data.
4. Update databases.

In some embodiments, it may be useful to determine the successfulness of particular domain names or sub-domain names in one or more search engines. Such determinations may be made periodically to compensate for changes in search engines or web crawlers. In some embodiments, the names of domain pages or sub-domain pages may be altered to reflect the information acquired. In other embodiments, the names of domain pages or sub-domain pages may remain the same, but the names of new pages may reflect the information acquired from the testing of names. Such a test may be performed using some or all of the following steps:
1. Generate a sub-domain name for one or more sub-modules.
2. Link sub-domain name to a master domain.
3. Post sub-domain on web.
4. Test placement of web page based on sub-domain name.
5. Compare placement to other sub-domain names.
6. Store optimal sub domain names for later use.
7. Update databases.

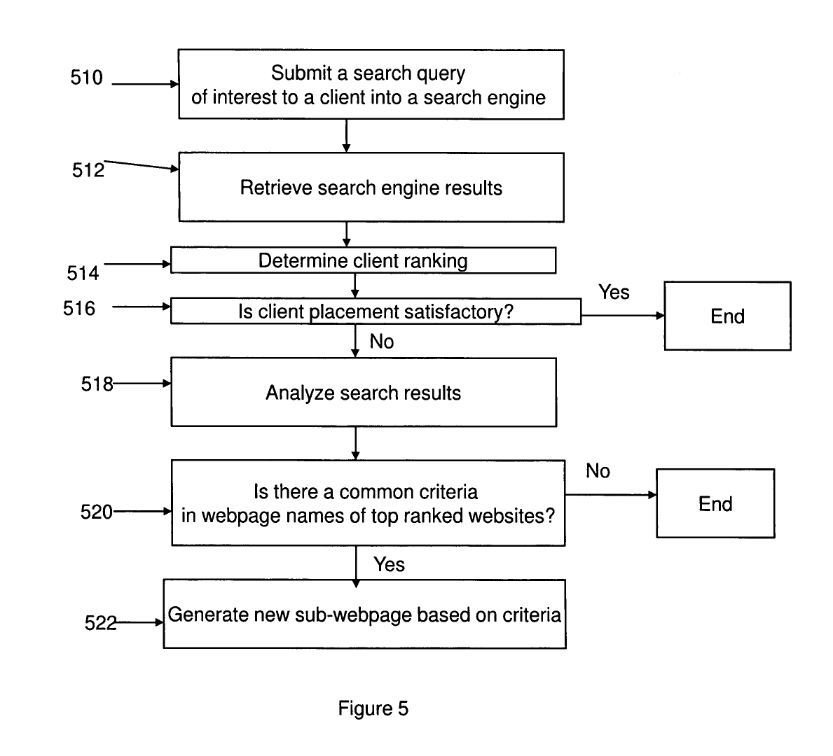

For example, some or all of the steps in FIG. 5 may be used to generate a new sub-webpage. A query designed for a target audience may be submitted to a search engine at 510. The results of the search may be retrieved 512 and a determination made to the placement of the clients' website at 514. If the placement is satisfactory 516, the program ends. If the placement is not satisfactory, the search results are analyzed at 518. A determination is made at 520 as to whether there is a common criterion in the web page names of the highest ranking web pages. That criterion may then be used to generate a new sub-webpage name or other web page name for the client at 522. If there is no common criterion, other methods of analysis may be applied. In some embodiments, the webpage names of existing sub-pages may be modified to reflect the newly discovered criterion.

It may additionally be useful to the replication system to determine how often sub-pages are visited. In some embodiments, the replication system may track the appearance and frequency of web crawlers on the master domain and sub-pages of clients.

### CONCLUSION

It will be appreciated that the configurations and routines disclosed herein are exemplary in nature, and that these specific embodiments are not to be considered in a limiting sense, because numerous variations are possible. The subject matter of the present disclosure includes all novel and nonobvious combinations and subcombinations of the various systems and configurations, and other features, functions, and/or properties disclosed herein.

The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

Although process steps, algorithms or the like may be described in a sequential order, such processes may be configured to work in different orders. In other words, any sequence or order of steps that may be explicitly described does not necessarily indicate a requirement that the steps be performed in that order. On the contrary, the steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not imply that all or any of the steps are essential or required. Various other embodiments within the scope of the described invention(s) include other processes that omit some or all of the described steps. Unless otherwise specified explicitly, no step is essential or required.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in this patent application. It is well known to one of ordinary skill in the art that a specified function may be implemented via different algorithms, and any of a number of different algorithms would be a mere design choice for carrying out the specified function.

We claim:

1. A method of affecting search results comprising:
having a master domain webpage;
retrieving data from a second website wherein the data retrieved is related to the content of the master domain webpage;
generating a sub-webpage based on the data from the website; and
linking the sub-webpage to the master domain webpage.

2. The method of claim 1, wherein the second website is a local vendor.

3. The method of claim 1, wherein the second website is a national aggregator.

4. The method of claim 1, wherein the sub-webpage is fully operable.

5. The method of claim 1, wherein the sub-webpage is based on a template.

6. The method of claim 1, wherein the sub-webpage is based on a category of information.

7. The method of claim 6, wherein the category of information is location, date, amenities, rating, price, or type of vendor.

8. The method of claim 1, wherein the sub-webpage is automatically generated.

9. The method of claim 1, wherein multiple sub-webpages are generated.

10. A method of affecting search results comprising;
submitting a first search query to a search engine;
analyzing the results of the search query;
having a master domain webpage; and
generating a sub-webpage name based on data in the master domain webpage wherein the specific sub-webpage name is determined by the results of the search query.

11. The method of claim 10, wherein the sub-webpage is linked to the master domain webpage.

12. The method of claim 10, further comprising submitting a second search query to a search engine to determine if the placement of the master domain webpage in the results list altered after the creation of the sub-webpage.

13. The method of claim 10, further comprising altering the names of existing sub-webpages based on the results of the first search query.

14. The method of claim 10, wherein the sub-webpage names is based on a category of data on the master domain webpage.

15. The method of claim 14, wherein the category of information is location, date, amenities, rating, price, or type of vendor.

16. A system comprising:
a master domain website;
a data scrape routine for obtaining information from a second website;
a webpage creation routine; and
a means for verifying a change in the placement of the master domain website in a search result.

17. The system of claim 16, wherein the webpage creation routine creates new webpages that are related to the master domain website.

18. The system of claim 17, wherein the new webpages are based on categories of information found on the master domain website.

19. The system of claim 17, wherein the new webpages are linked to the master domain website.

20. The method of claim 16, wherein the second website contains information related to the master domain website.
